(19) United States
(12) Patent Application Publication
(10) Pub. No.: US 2005/0060868 A1
(43) Pub. Date: Mar. 24, 2005

(54) Re-orientatable sample holder

(76) Inventor: David R. McMurtry, Gloucestershire (GB)

Correspondence Address: OLIFF & BERRIDGE, PLC, P.O. BOX 19928, ALEXANDRIA, VA, 22320, US

(21) Appl. No.: 10/500,714

(22) PCT Filed: Jan. 22, 2003
(86) PCT No.: PCT/GB03/00251

(30) Foreign Application Priority Data
Jan. 22, 2002 (GB) 0201362.1

(51) Int. Cl. B23Q 17/00; B23P 13/00

(52) U.S. Cl. 29/559; 29/896.1; 29/407.04; 269/902

(57) ABSTRACT

A device is disclosed having a base (2), and a re-orientatable sample holder (4) adapted on at least first and second sides to be repeatably (perhaps kinematically) mounted to the base (2) wherein the relationship between the at least two surfaces when mounted on the base is known whereby when a sample (13) is mounted to the holder, the relationship between the different orientations of the sample when different surfaces of the holder are received on the base is known. The relationship between the at least two surfaces may be established by reference features on the sample holder (4) which provide positional information about the holder when received on a base. The reference features may be provided by a reference block, spheres or rods associated with the holder. Also disclosed is a device for and methods of operating on, for example scanning or machining, a sample in at least two stages using a base and re-orientable sample holder according to the invention.

This invention relates to a reorientable sample holder whose location and orientation can be determined. For example, it may be used for the scanning of samples in two stages and matching together the data from the two stages providing coherent information. A preferred form relates to the scanning of dentalware such as frameworks for dentures.

One way that three-dimensional samples are scanned involves a stationary sample, a probe having three dimensional movement and styli that can access the whole surface of the sample including the underside enabling the whole surface to be scanned.

A problem with this method is that the equipment used requires a relatively large working space so it is unsuitable for situations where there are size limitations. A solution to this problem is to rotate the sample during the scanning process as this reduces the number of degrees of freedom that the probe requires. However, this solution results in further problems when scanning samples which have undercuts as this can lead to incomplete scans. Different problems are encountered when elongate samples, such as dental bridges, are involved.

The present invention provides a device comprising:
a base; and
a re-orientatable sample holder adapted on at least first and second sides to be repeatably mounted on the base characterised in that the relationship between the at least two surfaces when mounted on the base is known whereby when a sample is mounted to the re-orientatable sample holder, the relationship between the different orientations of the sample when different surfaces of the re-orientatable sample holder are received on the base is known.

The surfaces of the re-orientatable sample holder which are adapted to be repeatably mounted on the base have a unique relationship to each other which can be mathematically defined. Thus, the sample holder can be re-orientated without losing the location of a first surface with respect to the base, and a sample located thereon. One way to mathematically define this relationship is by using reference features.

The relationship between the at least two surfaces of the re-orientatable sample holder is established by a plurality of reference features on the re-orientatable sample holder which provide positional information about the re-orientatable sample holder when received on a base. Positional information includes one or more of translational and rotational information.

Reference features may be provided by one of a number of methods including the provision of a reference block of material of known dimensions and having machined faces which adjoins or forms part of the re-orientatable sample holder. Alternatively three spheres or rods may be provided which protrude from the re-orientatable sample holder and are accessible regardless of which surface of the re-orientatable sample holder is received on the base. Other references may be taken from the sample holder itself.

In a preferred embodiment, the reference features are provided by surfaces which are commensurately larger than a device used to locate the surfaces in space (a probe or laser spot, for example) whereas the sample holder must be of sufficient size to hold and/or support a sample. If the reference features are on such a block of material, machining costs are reduced. This is because the sample holder does not have to be machined to the same degree of precision as it would have been to provide the reference features.

In a preferred embodiment, the re-orientatable sample holder is kinematically or quasi-kinematically received on the base by a kinematic mount. This ensures that when the sample holder is re-orientated, the position of an attached sample with respect to the new orientation will either be known (if the reference features have been datumed for that sample holder on that base previously) or can be determined using the reference features.

According to a second aspect of the present invention, there is provided a device enabling operation on a sample in at least two stages comprising:
a base;
a re-orientatable sample holder adapted on at least first and second sides to be repeatably mounted on the base; and
an operating system for operating on the sample when the at least first and second sides of the re-orientatable sample holder are repeatably mounted on the base;
characterised in that the relationship between the at least first and second sides of the re-orientatable sample holder when mounted on the base is known enabling the at least two stages of an operation to be joined or matched.

Preferably, the relationship between the at least first and second sides of the re-orientatable sample holder is established by a plurality of reference features on the re-orientatable sample holder which provide positional information about the re-orientatable sample holder when received on the base.

According to a third aspect of the present invention there is provided a method of operating on a sample in at least two stages comprising:
providing a base;
locating a re-orientatable sample holder on the base the re-orientatable sample holder being adapted on at least first and second sides to co-operate with the base;
providing a plurality of reference features capable of supplying data about the position of the re-orientatable sample holder; and
furnishing an operating system;
wherein a first operation is made by the operating system when the first side of the re-orientatable sample holder co-operates with the base and a second operation is made when the second side of the re-orientatable sample holder co-operates with the base and the at least two operations are matched together using the data provided by the reference features.

According to a fourth aspect of the present invention there is provided a method of operating on a sample in at least two stages comprising the steps of:
providing a base;
providing a re-orientatable sample holder which is adapted to be received kinematically on the base on at least first and second sides wherein the relationship between the first and second sides is known;
placing the re-orientatable sample holder on the base on its first side;
operating on a first stage of a sample held in the sample holder;
re-orientating the sample holder with respect to the base onto its second side; and
operating on a second stage of a sample held in the sample holder; wherein the
operations of the first and second stages of the sample are matched using the relationship between the first and second sides.

When a kinematic location is used, the reference features for a particular pair of holder and base do not need to be re-datumed or re-referenced for future operations.

An operation includes the performance of a practical work on a sample such as scanning a surface profile, machining the sample, inspecting it or measuring it in some other manner.

The invention will now be described by example with reference to the accompanying drawings, in which:

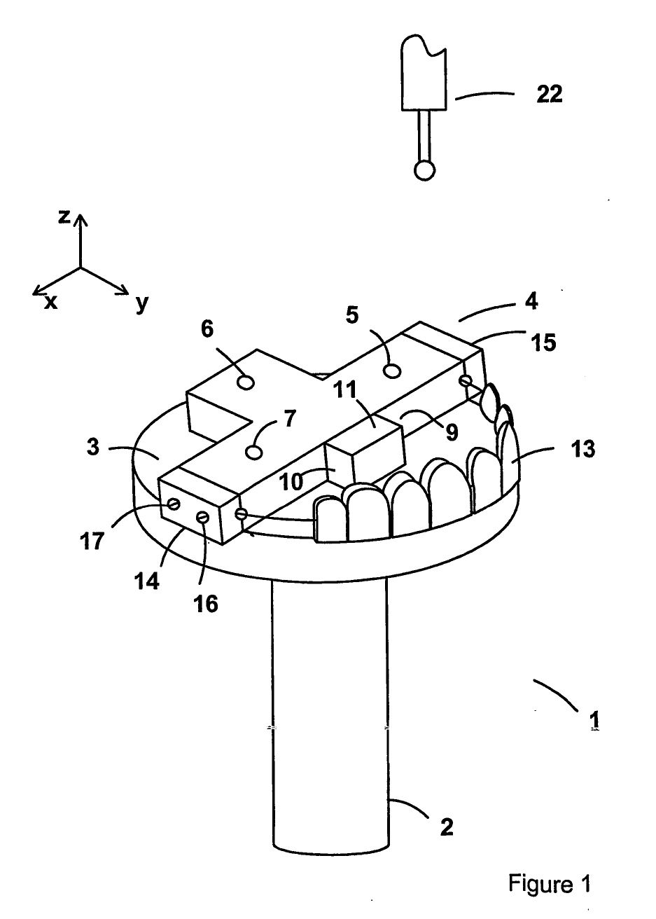

FIG. 1 shows an isometric view of a scanning apparatus using a device according to the invention;

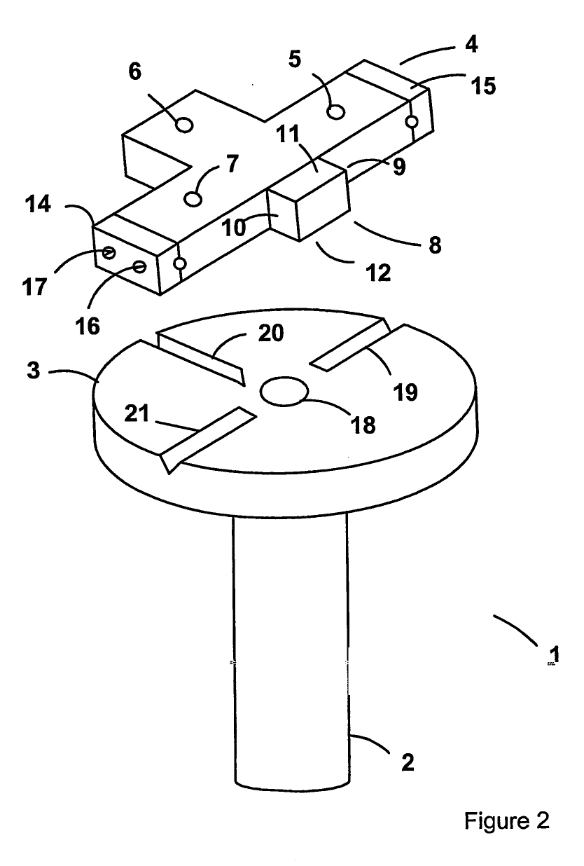

FIG. 2 shows an isometric view of device according to the invention;

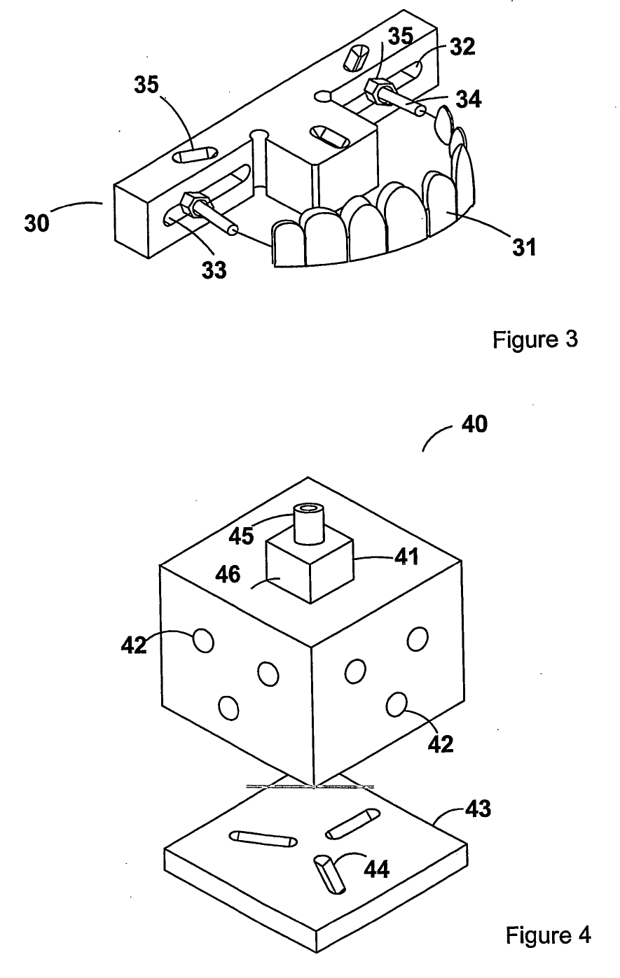

FIG. 3 shows an isometric view of a further device according to the invention;

FIG. 4 shows an isometric view of an alternative device according to the invention;

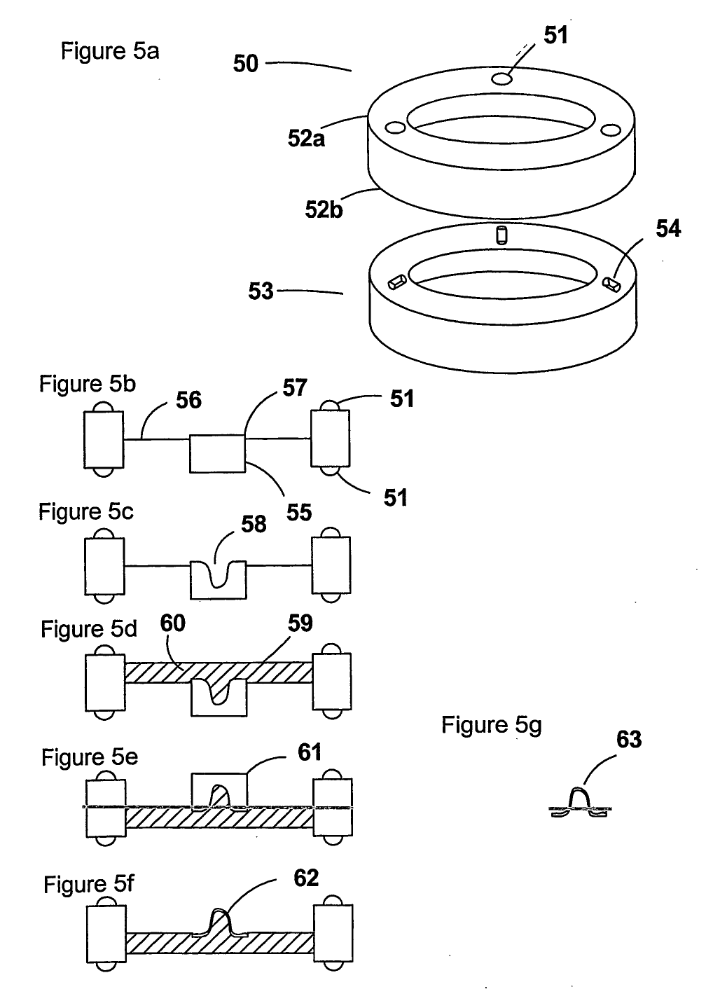

FIGS. 5a-g show schematically the manufacture of a dental coping using a device according to the invention;

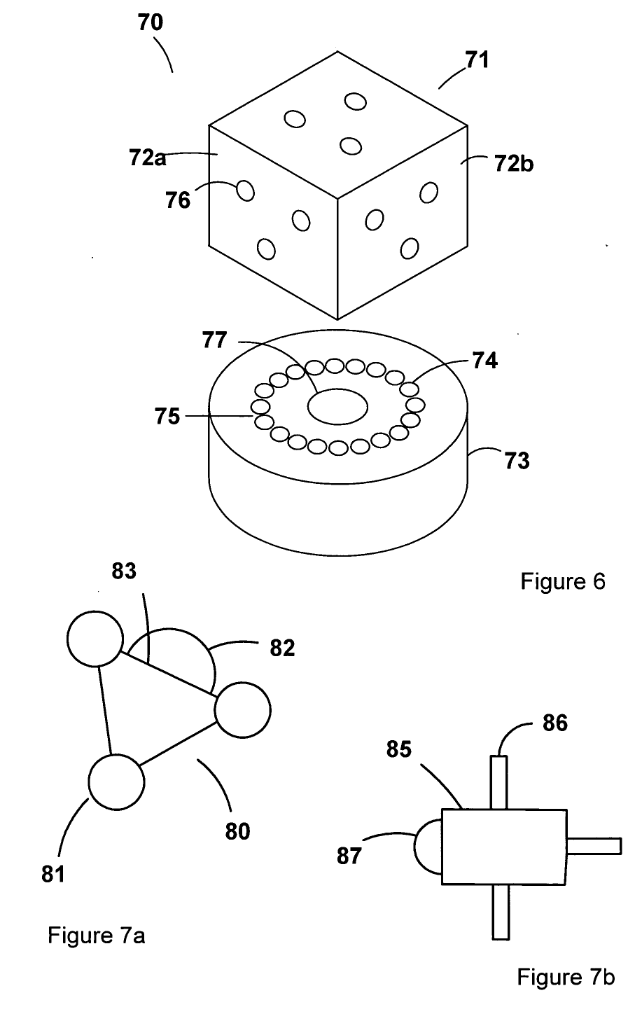

FIG. 6 shows isometrically an indexable device according to the invention; and

FIGS. 7a and b show plan views of re-orientatable sample holders according to the invention.

FIGS. 1 and 2 show a device 1 having a base 2 with a support surface 3. A re-orientatable sample holder 4 is T-shaped and has three ball bearings 5,6,7 embedded in both its upper surface and in its lower surface (not shown). One ball bearing is disposed near each end of the ‘T’ on each side. A cube 8 is adjoined to the re-orientatable sample holder 4 and has four machined faces 9,10,11,12 which provide reference features. A tooth framework 13 is secured to the sample holder 4 via removable end pieces 14, 15 which are secured by screws 16,17 to each end of the top of the ‘T’ of the sample holder.

The tooth framework 13 is attached to the sample holder by at least partially removing the screws 16, 17 that hold the end pieces 14,15 to the sample holder and inserting the ends of the framework 13. When the screws 16,17 of the end pieces 14,15 are tightened, the framework is held in position.

The reference features on cube 8 and the framework 13 are scanned by a contact probe 22. An alternative scanner would be a laser probe.

Referring now to FIG. 2, the support surface 3 has a magnet 18 disposed at its centre and three v-shaped grooves 19,20,21 lying radially spaced 90° apart (thus forming a ‘T’ shape). The three ball bearings 5,6,7 in each side of the re-orientatable sample holder 4 are disposed so that one lies vertically above/below another thus, each set of three balls co-operates with the three v-shaped grooves 19,20,21 in the support surface 3. This means that when the sample holder is reversed with respect to the base, the sample holder and thus the sample held therein are located in substantially the same place.

It will be appreciated that the grooves 19,20,21 and balls 5,6,7 form a (slightly degenerate) kinematic mount. Kinematic mounts of various types are well known, and described in (for example) HJJ Braddick, “Mechanical Design of Laboratory Apparatus” Chapman and Hall, London, 1960. Other kinematic mounts (and quasi-kinematic or partly degenerate kinematic mounts) may be used instead.

In order to obtain a complete scan of the surface of the framework 13, the framework is secured to the sample holder 4 as described above. The sample holder 4 is then placed on the support surface 3 in an orientation such that each ball bearing 5,6,7 co-operates with a groove 19,20,21. The magnet 18 ensures that this position is maintained until the sample holder 4 is removed from the base 3. Assuming this is the first scan using this holder and base i.e. the relationship between the two surface it not known, then firstly reference features are pinpointed followed by a scan of the upper portion of the framework 13. Once this first part of the scan is complete, the sample holder 4 is reversed with respect to the base 3. Reference features for this second surface are pinpointed or located this time however, the reference feature for the vertical position is taken from a different face of the reference block 8 as the sample holder 4 is now reversed compared with its original position. The lower portion of the framework 13 is now scanned.

As the sample holder is kinematically located on the base, the four reference surfaces 9,10,11,12 need only be referenced once in respect of that sample holder when used with that base. Thus, the above example would only apply on first use of that sample holder with that base. The reference information could then be stored either in writing or as a part of a scanning programme so a user need merely know which base and holder were being used to access the reference data (if available). For ease of matching the two scanned portions, the side of the sample holder on the base should also be identified.

In order to obtain both positional and rotational information about the sample holder, both the reference block and sample holder are datumed. The upper surface of the sample holder is datumed at least three times in order to define the plane of the surface and thus sample holder. The top surface 11 of the reference block provides positional information in the Z direction and side surfaces 9 and 10 about the X direction. An edge (either the top of the “T” or the parallel edge to this) of the sample holder is also datumed at two locations to establish the end location of the holder. This information is required for each surface of the holder which can be received on the base. In order to match the data from the different part scans, the other dimension required is the depth of the reference block between the two surfaces. Note when there are more than two surfaces capable of being received, this dimension will be different for each pair of surfaces. The person skilled in the art will appreciate that there are alternative ways of obtaining the data needed to establish where the sample holder is in space.

One such alternative to providing reference features in order to match-up part scans (or other operations), is to use computer software and processing to re-orient and re-position the part scans in relation to each other and thus enable the production of a more complete scan.

The reference block 8 is accurately machined so that each face is perpendicular to the adjacent faces. The distance between each set of opposite faces of the block needs to be known or measured (preferably under the same conditions as the framework scan). The references taken for each part of the scan in conjunction with the distance between the opposite faces of the block can then be used to match the two stages or parts of the scan (using appropriate computer software) adjusting said scans to take in consideration differences in the height and rotation of each part scan resulting in a complete matched scan of the framework.

When only two parts of a scan are being matched, it is less important to know which orientation is being scanned at one time as there are only two different ways that the data can be matched. When there are more scanning stages to be matched, it is advised that the orientation of the sample holder is also identified to avoid complications and possible errors when applying the reference data to the scanned data.

If computer software and processing is used to match-up part operations rather than reference features, then identification of the surface received on the base is useful in order that the programme can learn how the different part operations are likely to fit together, reducing processing time.

FIG. 3 shows a further sample holder 30 where the sample 31 is secured to the sample holder 30 using two slots 32,33 through the thickness of the sample holder. The sample 31 is secured at each end by glue to a threaded cylinder 34. The cylinder 34 is secured with respect to the slot by two nuts 35, one located either side of the slot 32,33.

In this example, the kinematic locator is reversed. The sample holder has three “v” shaped grooves 35 and a matching base (not shown) would have three co-operating balls protruding therefrom. Also, in this example the ends of the holder adjacent to 32 and 33 could be datumed to establish the x-direction location of the sample holder when on a base.

FIG. 4 shows an alternative device 40 which is a cube having a sample holder 41 on one face and kinematic locators 42 which are three balls radially disposed by 120°, on each of the other faces. A base 43 has co-operating kinematic locators 44, which are three v-shaped grooves radially disposed by 120°.

In this example, the reference features are provided by the sample holder 41 which has a central collet 45 into which a sample or sample mount (for example a tube) may be inserted. The faces of the sample holder 41 are accurately machined to produce reference surfaces 46. By measuring the distance from each face having a kinematic locator 42 to a respective reference surface 46 and the relative positions and orientations of each reference surface, the relative orientation and position of a sample (not shown) held by the sample holder 41 in each possible kinematic location 42 with respect to the base 43 is known or derivable. This enables an operation, for example scanning of a sample to be performed in a number of stages, perhaps required due to the shape of the sample, and the data obtained from these different stages to be matched together to produce a complete (if required) scan by the manipulation of each scanned data set using the measured information.

If a replica of the scanned sample is required, a machining process could be carried out using the same sample holder and base enabling the machining to either replicate the different scanning steps or, if more appropriate, to follow a route developed from the scanned data which provides the most efficient or least complicated process. A device according to the invention could also be used for the inspection of samples.

Although the device has been described as a cube, it will be appreciated that any number of faces (two or more) may be utilised depending on, amongst other things, size of sample, shape of sample, complexity and available working space.

FIGS. 5a-g show schematically the manufacture of a dental coping. The re-orientatable holder 50 is cylindrical in shape and has a kinematic locator 51 comprising three ball bearings radially spaced 120° apart on each rim 52a,b. A base 53 has a co-operating kinematic locator 54, three v-shaped grooves radially spaced 120° apart and describing a circle of the same diameter as the three ball bearings (FIG. 5a).

The re-orientatable holder 50 may thus be positioned on the base 53 in two positions, one the reverse of the other. For clarity, reference features have not been shown in this drawing.

During the manufacture of a coping, both the internal and external surfaces of a blank must be machined. The external surface is produced as a replica of the original tooth shape and the internal surface is produced to fit onto an abutment which locates the tooth within a mouth. An ability to reverse the position of the coping during the manufacture is therefore advantageous.

The blank 55 is held in position on the re-orientatable holder 50 by a disc 56 which is in two parts and has a central hole (formed from a semi-circular hole in each part). The two parts of the disc 55 are attached by screws which allow a variability in the size of a blank 54 to be accommodated. Alternatively the disc 56 may be one piece, which has a slot and central hole to accommodate the blank, the disc being clamped by a screw.

The blank 55 is positioned with respect to the disc such that one end 57 of the blank is approximately level with the disc (FIG. 5b).

The disc 56 is clamped to the re-orientatable device 50 by screws. Alternatively, the disc 56 is integrally formed as part of the re-orientatable holder which has a slot and is ring clamped to secure the blank centrally therein.

Once the disc 56 and blank 55 are securely positioned in the re-orientatable device, an internal bore 58 is produced by machining the end 57 of the blank which is almost level with the disc 56 (FIG. 5c).

In order to provide stability to the blank for the second machining process, the internal bore 58 and a region 59 defined by the re-orientatable device is temporarily filled with a resin 60 (FIG. 5d). Once the resin has cured sufficiently to provide strength and rigidity to the blank 55, the re-orientatable device 50 is reversed (FIG. 5e), so the end 61 of the blank which stands proud of the disc is available for machining.

The outer surface of the end 61 of the blank is machined to produce the final shape of the coping 62 (FIG. 5f). The resin is burned away leaving the coping 63 (FIG. 5g). If the blank 55 is made from a ceramic material, then the burn-off could be incorporated as part of the sintering process that occurs after machining.

The material used to support the partially machined blank need not be a resin but must be a removable material which provides sufficient support for the blank for example a wax or low melting point alloy.

FIG. 6 shows an indexable device 70 comprising a circular base portion 73 with a plurality of ball bearings 74 disposed circumferentially around it. In between each ball bearing is a gap 76 which is approximately v-shaped. At the centre of the base portion 73, is a magnet 77 used to urge the re-orientatable device into position. A re-orientatable device 71 is a cube having on at least two faces 72a,b three radially spaced apart ball bearings 76 which describe a circle having substantially the same diameter as the plurality of ball bearings 74 in the base 73. The three radially spaced ball bearings 76 are spaced 120° apart and adapted to sit in the v-shaped gaps 75 formed between the plurality of ball bearings 74. This provides a number of different orientations in which the re-orientatable device may be located.

Alternatively, three v-shaped grooves may be provided thus, the re-orientatable device sits on the ball bearings rather than within the grooves therebetween. In both cases, a force is required to move the re-orientatable device out of its current position.

If the plurality of ball bearings 74 are accurately positioned, then the re-orientatable device 71 can be indexed between different pairs of ball bearings enabling precise angular movement of say 7.5 or 15° intervals. This would enable small rotations of a sample held in a sample holder (not shown) on a face without the kinematic locators.

In addition to angular re-orientation, the re-orientatable device 71 may be relocated onto a different face 72b which may again be angularly re-orientated enabling a great number of orientations to be achieved.

FIGS. 7a and 7b show alternative embodiments of the invention where the repeatable locator itself is used to provide the initial reference or datum features used to relate two sides of a re-orientatable sample holder together.

The re-orientatable sample holder of FIG. 7a, 80 is approximately triangular in shape having a ball bearing 81 disposed at each apex. A framework 82 is mounted or attached to one of the sides 83 of the sample holder. The three ball bearings 81 have a diameter which is larger than the thickness of the approximately triangular-shaped central portion of the sample holder. Thus, both sides of the sample holder may be repeatably located (in this example kinematically located) with respect to a base (not shown) by the provision of three v-shaped grooves or pairs of balls to provide a seating for each respective ball bearing 81. Once each ball bearing 81 has been datumed from each side whilst received on a particular base, and with knowledge of the diameter of the ball bearings 81, the operation on one side of a sample held in the sample holder can be related to an operation on the reverse side. The datuming of the three balls provides the planar information about the re-orientatable sample holder.

FIG. 7b shows a rectangular re-orientatable sample holder 85 with three rods 86 protruding from three sides of the sample holder. The three rods lie in substantially the same plane. A sample holder 87 is attached to a fourth side and also lies in approximately the same plane as the rods. A base (not shown) in this example requires a groove within which each rod can be seated which may be raised with respect to the base surface for example, as formed by two protruding balls. The base may additionally or alternatively include a recess to accommodate the thickness of the sample holder which lies below the rod when seated on the base. Again, each rod must be datumed, when each side of the sample holder is seated on the base. This information along with the diameter or thickness of the rod provides enough information to match two operations carried out on a sample with different sides of the sample holder seated on the base.

1. A device comprising:
a base; and a re-orientatable sample holder adapted on at least first and second sides to be repeatably mounted on the base;
characterised in that the relationship between the at least two surfaces when mounted on the base is known whereby when a sample is mounted to the re-orientatable sample holder, the relationship between the different orientations of the sample when different surfaces of the re-orientatable sample holder are received on the base is known.

2. A device according to claim 1, wherein the relationship between the at least two surfaces of the re-orientatable sample holder is established by a plurality of reference features on the re-orientatable sample holder which provide positional information about the re-orientatable sample holder when received on a base.

3. A device according to claim 2, wherein the reference features are provided by a reference block of known dimensions and having machined faces which adjoins the re-orientatable sample holder.

4. A device according to claim 2, wherein the reference features are provided by three spheres or three rods which protrude from the re-orientatable sample holder and are accessible regardless of which surface of the re-orientatable sample holder is received on the base.

5. A device according to claim 1 wherein the re-orientatable sample holder is kinematically received on the base by a repeatable mount.

6. A device according to claim 1 wherein the re-orientatable sample holder is adapted to receive teeth frameworks.

7. A device enabling operation on a sample in at least two stages comprising:
a base;
a re-orientatable sample holder adapted on at least first and second sides to be repeatably mounted on the base; and
an operating system for operating on the sample when the at least first and second sides of the re-orientatable sample holder are repeatably mounted on the base;
characterised in that the relationship between the at least first and second sides of the re-orientatable sample holder when mounted on the base is known enabling the at least two stages of an operation to be matched.

8. A method of operating on a sample in at least two stages comprising:
providing a base;
locating a re-orientatable sample holder on the base the re-orientatable sample holder being adapted on at least first and second sides to co-operate with the base;
providing a plurality of reference features capable of supplying data about the position of the re-orientatable sample holder; and
furnishing an operating system;
wherein a first operation is made by the operating system when the first side of the re-orientatable sample holder co-operates with the base and a second operation is made when the second side of the re-orientatable sample holder co-operates with the base and the at least two operations are matched together using the data provided by the reference features.

9. A method of operating on a sample in at least two stages comprising the steps of:
providing a base;
providing a re-orientatable sample holder which is adapted to be received kinematically on the base on at least first and second sides wherein the relationship between the first and second sides is known;
placing the re-orientatable sample holder on the base on its first side;
operating on a first stage of a sample held in the sample holder;
re-orientating the sample holder with respect to the base onto its second side;
operating on a second stage of a sample held in the sample holder;
wherein the operations of the first and second stages of the sample are matched using the relationship between the first and second sides.

10. A device according to claim 2 wherein the re-orientatable sample holder is kinematically received on the base by a repeatable mount.

11. A device according to claim 3 wherein the re-orientatable sample holder is kinematically received on the base by a repeatable mount.

12. A device according to claim 4 wherein the re-orientatable sample holder is kinematically received on the base by a repeatable mount.

13. A device according to claim 2 wherein the re-orientatable sample holder is adapted to receive teeth frameworks.

14. A device according to claim 3 wherein the re-orientatable sample holder is adapted to receive teeth frameworks.

15. A device according to claim 4 wherein the re-orientatable sample holder is adapted to receive teeth frameworks.

16. A device according to claim 5 wherein the re-orientatable sample holder is adapted to receive teeth frameworks.
